(19) United States
(12) Patent Application Publication
(10) Pub. No.: US 2011/0241360 A1
(43) Pub. Date: Oct. 6, 2011

(54) LID LOCK APPARATUS FOR VEHICLE

(75) Inventor: Toshihiro KITAMURA, Okazaki-shi (JP)

(73) Assignee: AISIN SEIKI KABUSHIKI KAISHA, Kariya-shi (JP)

(21) Appl. No.: 13/071,620

(22) Filed: Mar. 25, 2011

(30) Foreign Application Priority Data
Mar. 31, 2010 (JP) 2010-081102

(51) Int. Cl. E05B 65/19; E05C 3/14

(52) U.S. Cl. 292/201

(57) ABSTRACT

A lid lock apparatus for a vehicle, includes a driving motor, a shaft member configured so that a first end portion thereof protrudes from a housing to be engageable with a lid body of a vehicle body, thereby retaining the lid body unopenable, and so that the shaft member retracts in response to an actuation of the driving motor, thereby being disengaged from the lid body, and an operating pull cord including a shaft engagement portion attached at a second end portion of the shaft member, a handle portion and a cord portion, which are made of a synthetic resin, so that the handle portion and the shaft engagement portion are integrally formed via the cord portion, and configured so as to retract the first end portion of the shaft member towards the housing when an operator pulls the handle portion, thereby disengaging the shaft member from the lid body.

### CROSS REFERENCE TO RELATED APPLICATIONS

This application is based on and claims priority under 35 U.S.C. §119 to Japanese Patent Application 2010-081102, filed on Mar. 31, 2010, the entire content of which is incorporated herein by reference.

### TECHNICAL FIELD

This disclosure generally relates to a lid lock apparatus for a vehicle for retaining a lid body, which is provided at a vehicle body, in a closed state.

### BACKGROUND DISCUSSION

Disclosed in JPH4-302680A is an example of a known lid lock apparatus retaining a lid body, which is configured so as to open and close a lid box provided at a vehicle body and accommodating therein a fuel filler, in a closed state. According to the lid lock apparatus disclosed in JPH4-302680A, the lid lock apparatus is configured so that a shaft member is normally biased in a direction by which the shaft member protrudes into the lid box by means of a spring, so that an end portion of the shaft member is engaged with the lid body (i.e. a locked position). In a case where a fuel is supplied to a vehicle through the fuel filler, the shaft member is retracted (i.e. the shaft member is pulled in a direction opposite to the direction by which the shaft member protrude into the lid box) by a worm wheel, which is actuated by an electric motor, thereby disengaging the shaft member from the lid body (i.e. an unlocked position).

Generally, a shaft member of a lid lock apparatus is provided with a pulling means for retracting (pulling) a shaft member in order to disengage the shaft member from a lid body in case of an emergency. In the case of the lid lock apparatus disclosed in JPH4-302680A, a wire for retracting (pulling) the shaft member to the unlock position is tied at a rear end portion thereof.

According to the lid lock apparatus disclosed in JPH4-302680A, a handle member, which is held by an operator, is connected to an end portion of the shaft member opposite to the rear end portion, at which the wire is connected. Therefore, in a case where the shaft member and the lid body are not disengageable from each other because of a malfunction of the electric motor and the like, the shaft member is allowed to be retracted (pulled back) by the operator by pulling the handle member, which is accommodated within a trim of the vehicle body.

According to the lid lock apparatus disclosed in JPH4-302680A, an end portion of the pulling wire is inserted into a through hole, which is formed at the rear end portion of the shaft member, and then is folded back, so that the end portion of the wire is caulked by a collar member at a predetermined portion of the wire, thereby connecting the wire to the shaft member. On the other hand, the other end portion of the wire is inserted into the handle member, which is held by the operator, and is folded back, so that the other end portion of the wire is caulked by a collar member at a predetermined portion of the wire, thereby connecting the wire to the handle member.

Furthermore, there exists a known lid lock apparatus, which is configured so that a belt made of a webbing material is adapted as a pulling member. More specifically, both end portions of the belt are inserted into a shaft member and a handle member, respectively, and then are folded back, so that the both end portions of the belt are lock-stitched at predetermined positions thereof, respectively, in order to connect the belt with each of the shaft member and the handle member. Accordingly, in a manufacturing process, processes of inserting both end portions of a material such as the wire and the like into the shaft member and the handle member, respectively, and of caulking or stitching are necessary. Therefore, because the wire and the like are connected to the shaft member and the handle member while adjusting a length of the wire, the known lid lock apparatuses are nonproductive and furthermore, manufacturing costs of the known lid lock apparatuses may be increased.

Furthermore, according to the known lid lock apparatuses, because a gauge and the like needs to be used in order to accurately adjust the length of the wire and the like, the manufacturing costs may be further increased. Additionally, generally, the pulling wire is made of a stainless material in view of a strength, a rust-resistance and the like. Therefore, the manufacturing costs of the known lid lock apparatuses may be increased because of materials used for the known lid lock apparatuses.

A need thus exists to provide a lid lock apparatus for a vehicle which is not susceptible to the drawback mentioned above.

### SUMMARY

According to an aspect of this disclosure, a lid lock apparatus for a vehicle, includes a driving motor accommodated within a housing, a shaft member supported within the housing so as to be movable in an axial direction thereof and configured so that a first end portion of the shaft member protrudes from the housing to be engageable with a lid body provided at a vehicle body in order to retain the lid body to be unopenable by an engagement between the first end portion of the shaft member and the lid body and so that the shaft member retracts in response to an actuation of the driving motor in order to disengage the shaft member from the lid body, and an operating pull cord including a shaft engagement portion made of a synthetic resin material and attached at a second end portion of the shaft member, a handle portion formed with the shaft engagement portion as a unit by the synthetic resin material and being holdable by an operator and a cord portion integrally formed with the shaft engagement portion and the handle portion by use of the synthetic resin material and connecting the shaft engagement portion and the handle portion, and configured so as to retract the first end portion of the shaft member towards an inside of the housing when the operator pulls the handle portion in order to disengage the shaft member from the lid body.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exploded perspective view of a lid lock apparatus for a vehicle according to an embodiment;

FIG. 2 is a front view of the lid lock apparatus for the vehicle at an unlocked position in a case where an inside of the lid lock apparatus for the vehicle is viewed in a state where a cover is removed;

FIG. 3 is a front view of the inside of the lid lock apparatus for the vehicle at a locked position;

FIG. 4 is a partial diagram illustrating a state where a lock shaft and a lid of the lid lock apparatus for the vehicle are engaged with each other;

FIG. 5 is a diagram illustrating an entire emergency pull cord;

FIG. 6 is a perspective view of a handle illustrated in FIG. 5 when being viewed from behind;

FIG. 7 is a partial perspective view illustrating a state where the emergency pull cord is attached to the lock shaft;

FIG. 8 is a perspective view of a connecting portion between the emergency pull cord and the lock shaft illustrated in FIG. 7 when being viewed from a direction opposite to FIG. 7;

FIG. 9 is a cross-sectional diagram illustrating a state where the lock shaft and the emergency pull cord are engaged with each other taken along line IX-IX in FIG. 3;

FIG. 10 is a cross-sectional diagram illustrating the state where the lock shaft and the emergency pull cord are engaged with each other taken along line X-X in FIG. 3;

FIG. 11 is a diagram illustrating a state where a handle portion is attached at a vehicle body when being viewed from a side thereof; and

FIG. 12 is a diagram partially illustrating a modified example of a cord portion of the emergency pull cord.

### DETAILED DESCRIPTION

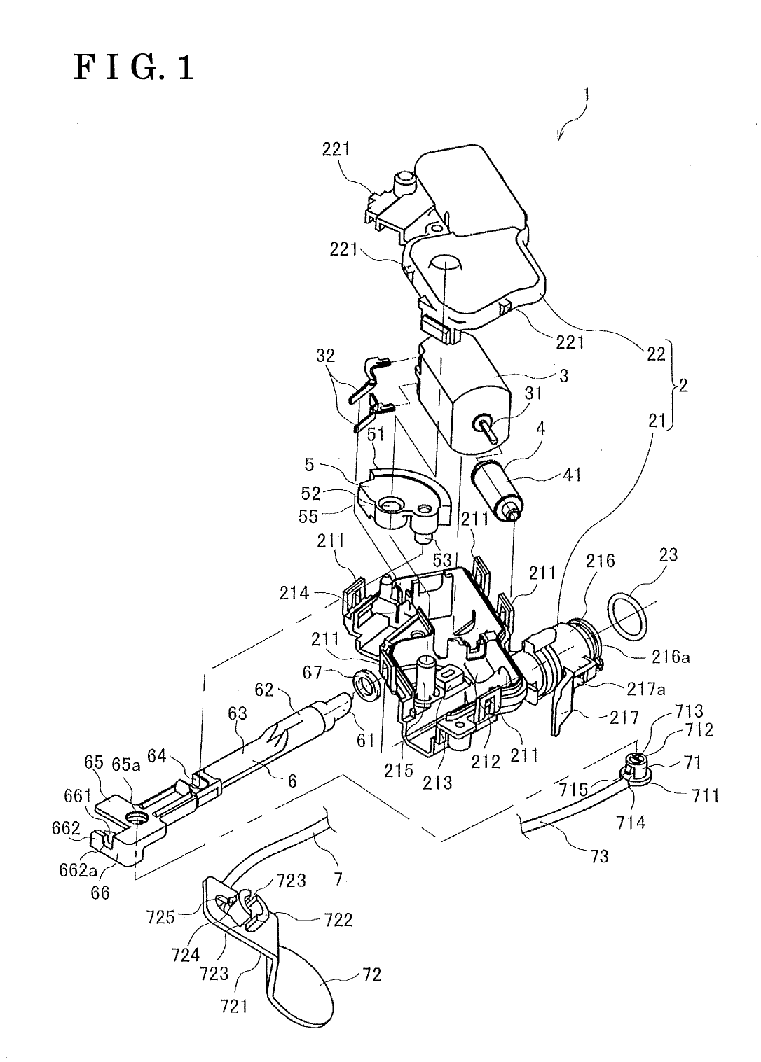

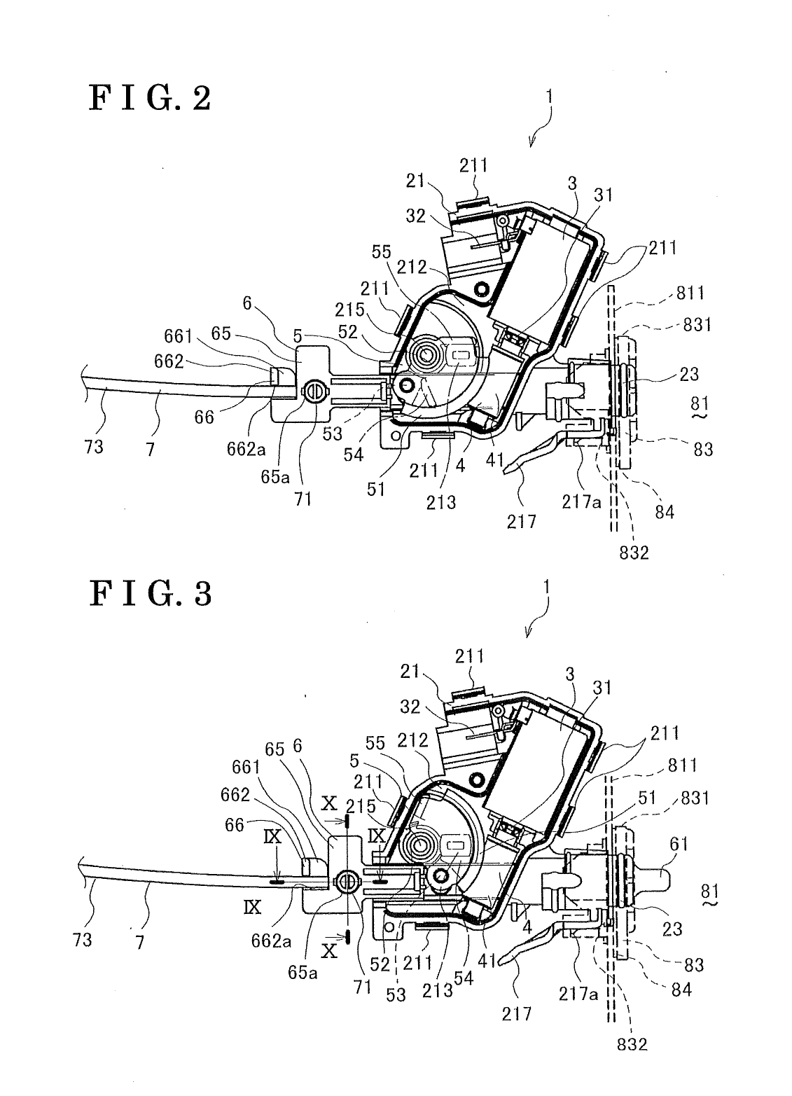

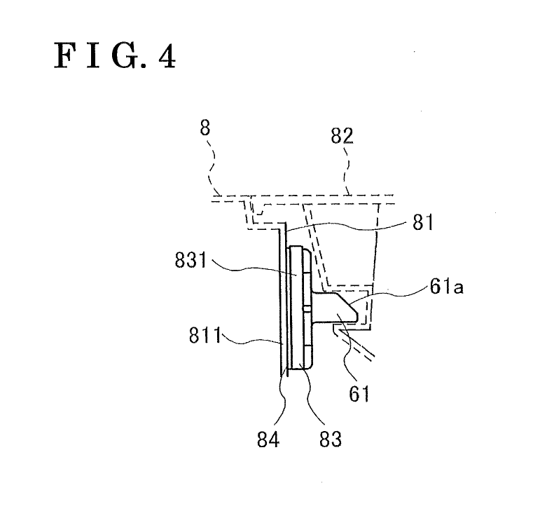

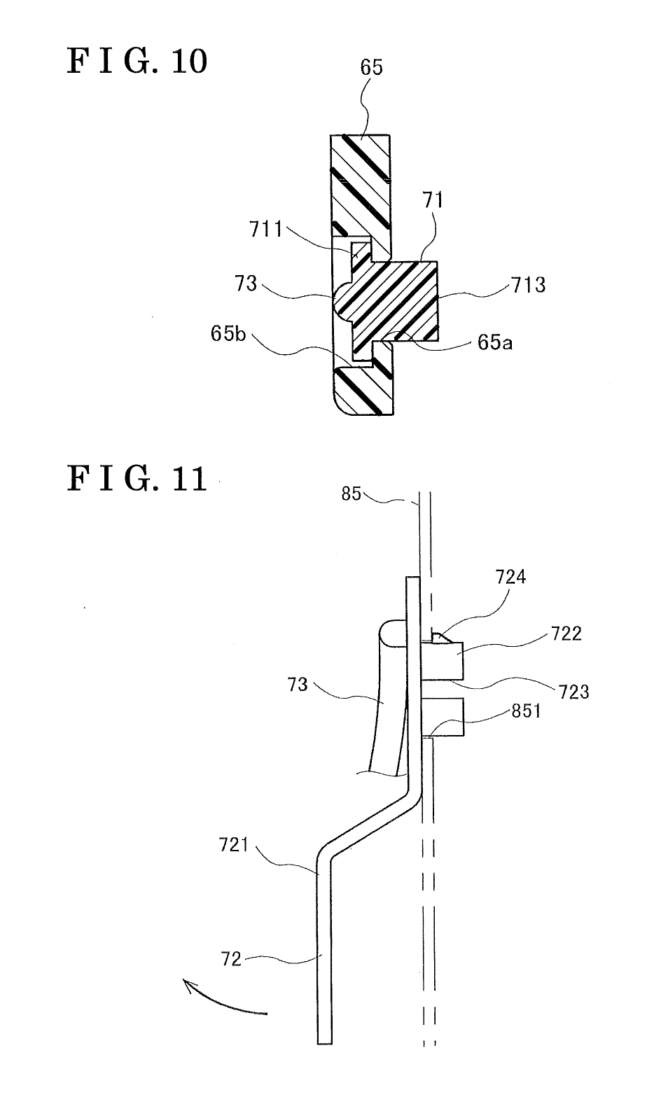

An embodiment of a lid lock apparatus for a vehicle, which will be hereinafter referred to as a lid lock apparatus 1, will be described below with reference to the attached drawings of FIGS. 1 to 11. Additionally, a right side in FIG. 2 is referred to as a front of the lid lock apparatus 1 and a left side in FIG. 2 is referred to as a rear of the lid lock apparatus 1 unless otherwise mentioned. The lid lock apparatus 1 is configured so as to be engageable with a lid 82, which is provided at a vehicle body 8 and which opens and closes a lid box 81 accommodating therein a fuel filler, in order to not allow the lid 82, which serves as a lid body, to be opened (see FIG. 4).

As illustrated in FIG. 1, the lid lock apparatus 1 is configured so that a body 21 and a cover 22 configure an actuator housing 2 (which serves as a housing and which will be hereinafter referred to as a housing 2). An electric motor 3 (which serves as a driving motor), a worm 4, a worm wheel 5, a lock shaft 6 (which serves as a shaft member), are accommodated within the housing 2.

Each of the body 21 and the cover 22 is made of a synthetic resin material. After the above-mentioned inner components are accommodated within the housing 2, the body 21 and the cover 22 are fitted to each other, and then, an engagement piece 211 of the body 21 (in this embodiment, plural engagement pieces 211 are formed at the body 21) is engaged with an engagement protruding portion 221 of the cover 22 (in which embodiment, plural engagement protruding portions 221 are formed at the cover 22) as an integrated unit. Furthermore, a wheel stopper 213 is formed on a bottom surface portion 212 of the body 21 so as to protrude therefrom. The wheel stopper 213 is formed in a substantially quadrangle cylinder-shape when being viewed from above in FIG. 1. Additionally, the wheel stopper 213 is integrally formed on the body 21.

An output shaft 31 of the electric motor 3 is press-fittedly inserted into the worm 4, so that the worm 4 is rotatable by the electric motor 3. The worm 4 is made of a metal or a synthetic resin material. Furthermore, a tooth portion is formed on an outer circumferential surface 41 of the worm 4. After the output shaft 31 of the electric motor 3 is press-fittedly inserted into the worm 4, in other words, after the electric motor 3 and the worm 4 are connected to each other as a unit, the electric motor 3 and the worm 4 are arranged on the bottom surface portion 212 of the body 21. A pair of motor terminals 32 through which electric power is supplied are fixed at a terminal retaining portion 214 of the body 21, so that the motor terminals 32 are electrically connected to the electric motor 3.

The worm wheel 5 is made of a synthetic resin material and is formed so that an outer circumferential surface 51 forms an arc shape (i.e. a substantially sectoral shape). A bearing bore 52 extends so as to penetrate through the worm wheel 5 in a thickness direction thereof. Furthermore, the worm wheel 5 includes an engagement column 53 protruding in a downward direction in FIG. 1. As illustrated in FIG. 2, a flat-shaped first stopper wall 54, which also extends in the downward direction, is formed on the worm wheel 5 so as to be positioned in the vicinity of the engagement column 53. On the other hand, a second stopper wall 55, which extends in the same direction as the first stopper wall 54 extends, is formed on the worm wheel 5 so as to be positioned in the vicinity of the bearing bore 52.

A wheel shaft 215, which is formed so as to protrude from the bottom surface portion 212 of the body 21, is fitted into the bearing bore 52 of the worm wheel 5, so that the worm wheel 5 is attached at the body 21 so as to be rotatable about the wheel shaft 215. A tooth portion is formed at the outer circumferential surface 51 of the worm wheel 5, so that the tooth portion of the worm wheel 5 is engaged with the tooth portion of the worm 4.

The lock shaft 6 is made of a synthetic resin material and is integrally formed in an elongated shape. A lock portion 61, which is configured so as to be engageable with the lid 82, is formed at a front end portion (i.e. a first end portion) of the lock shaft 6 (a right end portion of the lock shaft 6 in FIG. 2). The lock portion 61 is formed in a column shape and includes a taper portion 61a at an end portion of the column (see FIG. 4). A supporting portion 62 of the lock shaft 6 formed in the vicinity of the lock portion 61 is formed so as to be in a column shape having a greater diameter than the lock portion 61. A seal ring 67, which is made of a synthetic rubber material, is attached at the supporting portion 62. The lock portion 61 and the supporting portion 62 of the lock shaft 6 are inserted into a shaft retaining portion 216 of the body 21 while allowing the lock shaft 6 to be movable in an axial direction thereof.

An avoidance portion 63 is formed at a substantially intermediate portion of the lock shaft 6 so as to extend for a predetermined distance. The avoidance portion 63 is formed in a shape, which is obtained by cutting of a radially upper half portion of the supporting portion 62, in order to place the worm wheel 5 on the avoidance portion 63. Furthermore, an interlocking bore 64 is formed at the lock shaft 6 so as to be positioned rearwardly of the avoidance portion 63 and so as to penetrate the lock shaft 6 in a thickness direction thereof. The engagement column 53 formed at the worm wheel 5 is inserted into the interlocking bore 64. According to the above-mentioned configuration, the lock shaft 6 is accommodated within the housing 2 while being engaged with the worm wheel 5 and while being movable in the axial direction (i.e. in a right-left direction in FIG. 2).

A flat plate portion 65 is formed at the lock shaft 6 so as to be positioned rearwardly of the interlocking bore 64 (i.e. so as to be positioned at the left relative to the interlocking bore 64 in FIG. 2). The flat plate portion 65 includes a connecting hole 65a, at which an end portion of an emergency pull cord 7 is attached and which serves as an engagement hole), so as to penetrate the flat plate portion 65 in the same direction as an axial direction of the interlocking bore 64. A stepped hole 65b having a greater diameter than the connecting hole 65a is formed so as to extend from a rear portion of the connecting hole 65a (i.e. an upper portion of the connecting hole 65a in FIG. 9).

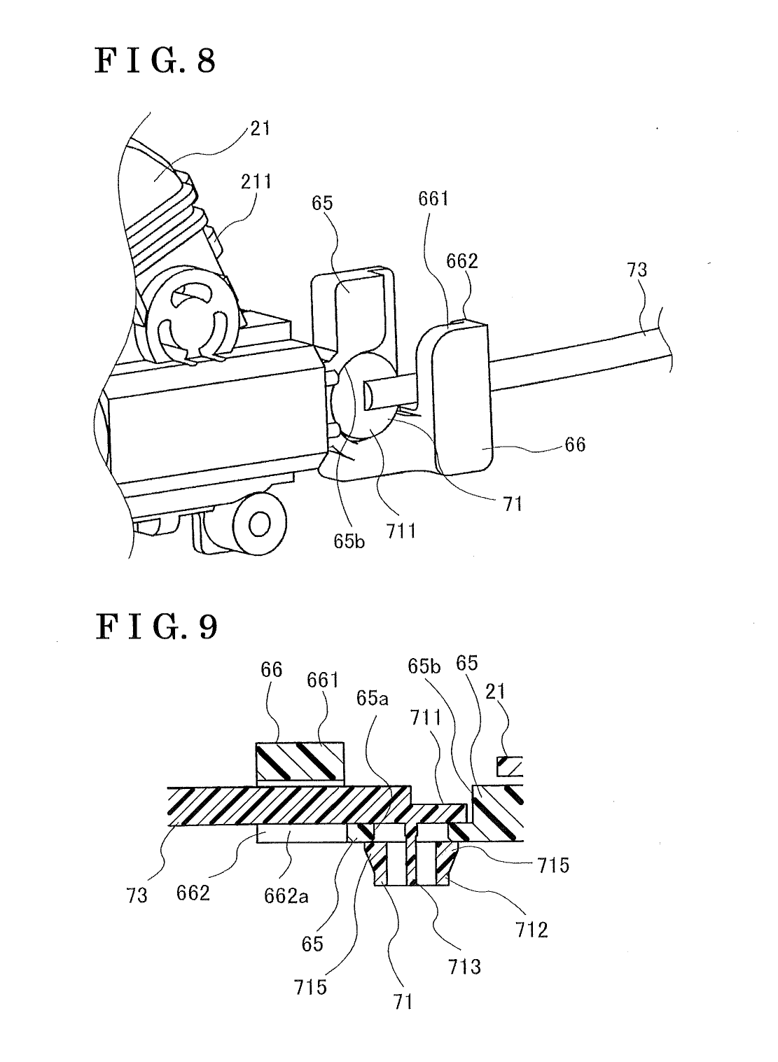

A cord guiding portion 66, which serves as a guide portion, for supporting the emergency pull cord 7 is formed at a rear end portion (a second end portion) of the lock shaft 6 integrally with the flat plate portion 65 as a unit. The cord guiding portion 66 includes a supporting portion 661 extending in the axial direction of the lock shaft 6 and a holding portion 662 extending in a direction orthogonal to the supporting portion 661, so that the cord guiding portion 66 is formed to have a substantially L-shape in cross-section (see FIGS. 7 and 8). A guide groove 662a, through which a cord portion 73 of the emergency pull cord 7 is inserted, penetrates through the holding portion 662.

After each component configuring the lid lock apparatus 1 is accommodated within the body 21, the cover 22 is fitted to the body 21, then, the engagement pieces 211 of the body 21 are engaged with the corresponding engagement protruding portions 221 of the cover 21 in order to connect the body 21 and the cover 22 as the unit. Accordingly, the electric motor 3, the worm 4, the worm wheel 5 and the lock shaft 6 are retained by means of the body 21 and the cover 22 without causing a backlash. A watertight ring 23 made of a synthetic rubber material is attached at a seal groove 216a formed at a front end portion of the shaft retaining portion 216 of the body 21.

As illustrated in FIG. 2, the lid lock apparatus 1 is attached at a support wall 811 of the lid box 81 via a retainer 83. The retainer 83 is not included as a component of the lid lock apparatus 1. Furthermore, the retainer 83 is attached on the support wall 811 so as to penetrate therethrough. A seal plate 84 is provided between an enlarged diameter portion 831 of the retainer 83, which protrude into the lid box 81 (to the right relative to the support wall 811 in FIG. 2) and the support wall 811, so that the lid box 81 is fluid-tightly closed. The shaft retaining portion 216 of the lid lock apparatus 1 is inserted into the retainer 83 so as to be fixed at the support wall 811, so that a clearance formed between the shaft retaining portion 216 and the retainer 83 is sealed by the watertight ring 23 provided therebetween.

As illustrated in FIG. 1, an operation lever 217 extends from the shaft retaining portion 216 of the lid lock apparatus 1 in the rearward direction. An engagement portion 217a protrudes from a predetermined portion of the operation lever 217. When the shaft retaining portion 216 is inserted into the retainer 83 to the right in FIG. 2, the engagement portion 217a contacts an inner circumferential surface of the retainer 83, thereby deflecting the operation lever 217 in an upward direction in FIG. 2. When the shaft retaining portion 216 is further inserted into the retainer 83, the operation lever 217 returns to an initial position, so that the engagement portion 217a of the operation lever 217 engages with a recessed portion 832 of the retainer 83 (see FIG. 2), thereby retaining the shaft retaining portion 216 so as not to be disengaged from the retainer 83.

Accordingly, while the shaft retaining portion 216 is attached at the retainer 83, even if the lock shaft 6 is displaced in the axial direction relative to the housing 2, the lid lock apparatus 1 is prevented from being disengaged from the vehicle body 8 because of the engagement between the engagement portion 217a and the recessed portion 832. Furthermore, even if the lock shaft 6 is pulled towards a position at which the lock shaft 6 is disengaged from the lid 82 by means of the emergency pull cord 7, the lid lock apparatus 1 is completely prevented from being disengaged from the vehicle body 8. On the other hand, in a case where the lid lock apparatus 1 is detached from the vehicle body 8, the operator applies a biasing force to the operation lever 217 in the upward direction in FIG. 2. Accordingly, the engagement portion 217a is disengaged from the recessed portion 832, so that the shaft retaining portion 216 is easily detached from the retainer 83 by pulling the shaft retaining portion 216 to the left in FIG. 2.

As illustrated in FIG. 2, the electric motor 3 is actuated in accordance with a predetermined operation condition while the lid lock apparatus 1 is at the unlock position, where the lock shaft 6 and the lid 82 are in an disengaged state. Accordingly, the worm wheel 5 is rotated in a counterclockwise direction in FIG. 2 about the wheel shaft 215 via the worm 4. Therefore, the lock shaft 6, which engages with the engagement column 53 of the worm wheel 5 at the interlocking bore 64, is displaced in the axial direction (to the right in FIG. 2) relative to the housing 2, so that the lock portion 61 protrudes outside the housing 2 (see FIG. 3: the locked position). While the lid lock apparatus 1 is at the locked position, the lock portion 61 protrudes into the lid box 81, so that the lock portion 61 engages with the lid 82, thereby retaining the lid 82 to be in a state where the lid 82 is not openable (see FIG. 4). Additionally, illustrated in FIG. 4 is a diagram of a front end portion of the lid lock apparatus 1 when being viewed from above in FIG. 3.

A rotation of the worm wheel 5, which is rotated by the worm 4, is stopped when the first stopper wall 54 contacts the wheel stopper 213. A controller connected to the electric motor 3 detects a load current of the electric motor 3 generated when the rotation of the worm wheel 5 is stopped. Then, the controller stops supplying the electric power to the electric motor 3.

Furthermore, as illustrated in FIG. 3, the electric motor 3 is actuated in accordance with a predetermined operation condition while the lid lock apparatus 1 is in a state where the lock shaft 6 is positioned at the locked position, so that the worm wheel 5 is rotated in a direction opposite to the rotation of the worm wheel 5 in the case where the electric motor 3 is actuated while the lid lock apparatus is at the unlocked position (i.e. in a clockwise direction in FIG. 3). Accordingly, the lock shaft 6 is displaced in the axial direction (i.e. to the left in FIG. 3) relative to the housing 2, so that the lock portion 61 is accommodated within the housing 2 (see FIG. 2, the unlocked position). The retracted lock portion 61 is disengaged from the lid 82, thereby allowing the lid 82 to be opened.

The rotation of the worm wheel 5, which is inversely rotated by the worm 4, is stopped when the second stopper wall 55 contacts the wheel stopper 213. The controller detects the load current of the electric motor 3 generated when the rotation of the worm wheel 5 is stopped. Then, the controller stops supplying the electric power to the electric motor 3.

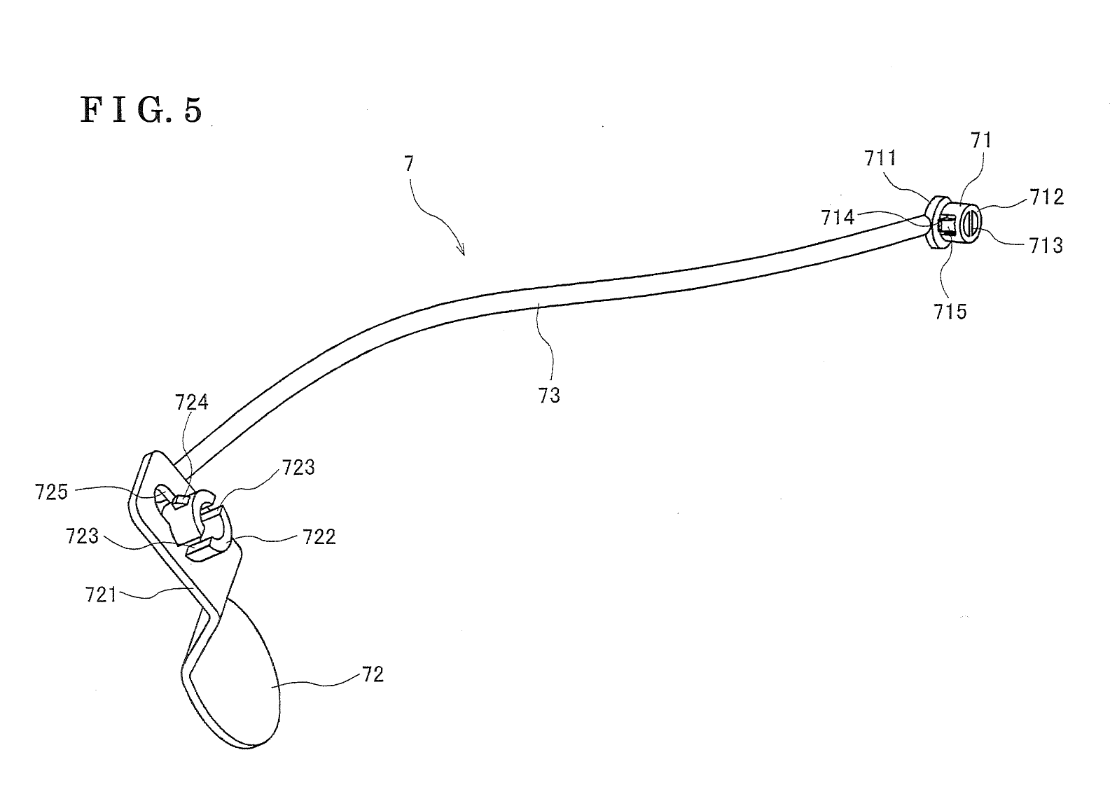

The emergency pull cord 7 (which serves as an operating pull cord) will be described below in detail. As illustrated in FIG. 5, the emergency pull cord 7 includes a shaft engagement portion 71 at a first end portion, a handle portion 72 at a second end portion and the cord portion 73. The shaft engagement portion 71 is attached at the connecting hole 65a of the lock shaft 6. The handle portion 72 is held and operated by the operator in an emergent case. The cord portion 73 connects the shaft engagement portion 71 and the handle portion 72. The emergency pull cord 7 is integrally formed by a synthetic resin material such as a nylon and the like (however, the material used for the emergency pull cord 7 is not limited to the nylon). In other words, the shaft engagement portion 71, the handle portion 72 and the cord portion 73 are integrally formed by the synthetic resin material as a unit.

As illustrated in FIG. 5, the shaft engagement portion 71 includes a circular plate portion 711 formed in a circle shape and an insertion portion 712, which is formed in a substantially cylinder shape and which protrudes from an upper surface of the circular plate portion 711. A bridge 713 is formed at the insertion portion 721 so as to connect portions of an inner circumferential surface facing each other. Furthermore, a rectangular-shaped through hole 714 is formed at two portions on a circumference of the insertion portion 712 facing each other (only one of two through holes 714 is illustrated in FIG. 5). A hook 715 protrudes in a radially outward direction from an end portion of each of the through holes 714 positioned away from the circular plate portion 711 (see FIG. 9). More specifically, each hook 715 is formed in a cantilever shape and is deformable in a radially inward direction of the insertion portion 712. Accordingly, the insertion portion 712 including the hooks 715 serves as a snap-fit fastener (a first snap-fit fastener). An outer diameter of the insertion portion 712 is formed slightly smaller than an inner diameter of the connecting hole 65a of the lock shaft 6. Furthermore, a distance between radially outer edge portions of the respective hooks 715 is formed to be greater than the inner diameter of the connecting hole 65a.

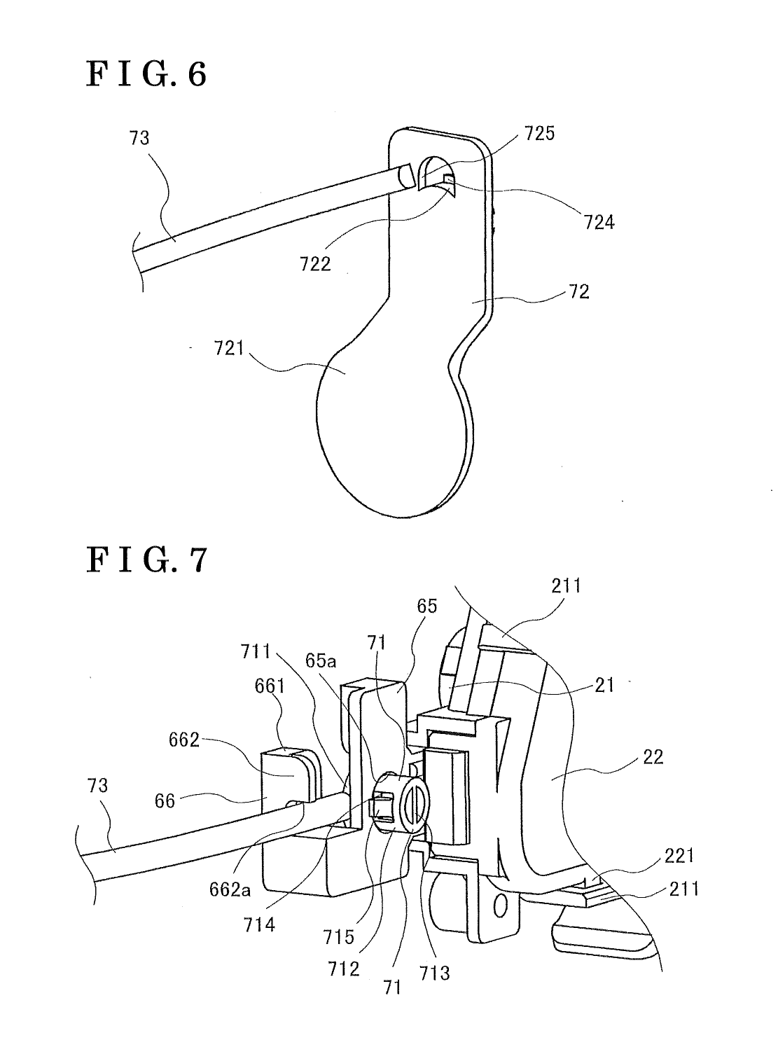

The handle portion 72 will be described below in detail. In the explanation of the handle portion 72, an upper side in FIG. 6 is referred to as an upper side of the handle portion 72. The handle portion 72 includes an operation plate 721, which is formed by bending a flat plate, and an attachment portion 722, which is formed in a substantially cylinder shape and which extends from an upper portion on a surface of the operation plate 721 (see FIG. 5). A slit 723 is formed at two portions on a circumference of the attachment portion 722 facing each other, thereby allowing the attachment portion 722 to be deformable in a radially inward direction (i.e. in an up-and-down direction of the handle portion 72). Accordingly, the attachment portion 722 serves as a snap-fit fastener (a second snap-fit fastener).

An engagement protrusion 724 is formed at an upper end portion of the attachment portion 722 so as to protrude upwardly. Furthermore, as illustrated in FIG. 6, a cut out hole 725 is formed at a portion of the operation plate 721 facing the engagement protrusion 724, in order to form the engagement protrusion 724 when forming the handle portion 72. The attachment portion 722 is formed so that an outer diameter thereof is slightly smaller than an inner diameter of an engagement hole 851 formed at an attachment wall 85 of the vehicle body 8. A distance from a center of the attachment portion 722 and a radially outer edge portion of the engagement protrusion 724 is formed to be greater than a radius of the engagement hole 851 (see FIG. 11).

The cord portion 73 connecting the shaft engagement portion 71 and the handle portion 72 is formed in a cord-shape whose cross-section forms a circular shape. The cord portion 73 is arranged so as to extend between an inner panel and an outer panel of the vehicle body 8. Additionally, because the cord portion 73 is arranged (wired) so as to avoid a contact with other components within the vehicle body 8, the cord portion 73 is formed to have a predetermined flexibility and a predetermined strength to bear a tension load applied thereto by the operator.

In a case where the shaft engagement portion 71 having the above-described configuration is attached to the lock shaft 6, firstly, the cord portion 73 is inserted into the guide groove 662a of the cord guiding portion 66, and then, the insertion portion 712 of the shaft engagement portion 71 is inserted into the connecting hole 65a of the lock shaft 6. Accordingly, the insertion portion 712 is moved into the connecting hole 65a while the pair of the hooks 715 are deformed in the radially inward direction. Then, after the hooks 715 pass through the connecting hole 65a, the hooks 715 return to an initial position, so that the shaft engagement portion 71 is fixed at the connecting hole 65a (see FIGS. 7 and 8). Accordingly, the shaft engagement portion 71 is prevented from being disengaged from the connecting hole 65a by means of the hooks 715.

While the shaft engagement portion 71 is attached at the lock shaft 6, the circular plate portion 711 is positioned within the stepped hole 65b. A clearance is formed between the hooks 715 and the circular plate portion 711 in the axial direction of the insertion portion 712 so as to have a same thickness as the flat plate portion 65 at which the connecting hole 65a is formed. Accordingly, the flat plate portion 65 is held between the hooks 715 and the circular plate portion 711 (see FIG. 9). After the shaft engagement portion 71 is attached at the lock shaft 6, a portion of the cord portion 73 in the vicinity of the shaft engagement portion 71 is inserted into the guide groove 662a of the cord guiding portion 66. Accordingly, the cord portion 73 is held by the support portion 661 and the holding portion 662, so that a posture of the cord portion 73 is maintained (see FIG. 7).

On the other hand, the handle portion 72 is attached at the attachment wall 85 of the vehicle body 8 (see FIG. 11). The attachment wall 85 is formed by, for example, an inner panel configuring a trunk and the like of the vehicle (however, the attachment wall 85 is not limited to the inner panel of the trunk). A right side relative to the attachment wall 85 in FIG. 11 corresponds to an inside of the trunk. Therefore, as illustrated in FIG. 11, the handle portion 72 is attached at the attachment wall 85 facing an outside of the vehicle. As illustrated in FIG. 11, the engagement hole 851 (which serves as an attachment hole) is formed at the attachment wall 85 so as to penetrate therethrough. In a case where the handle portion 72 is attached at the attachment wall 85, the attachment portion 724 is inserted into the engagement hole 851 while the attachment portion 722 is deformed in the radially inward direction as the engagement protrusion 724 contacts the engagement hole 851.

Then, after the engagement protrusion 724 passes through the engagement hole 851, the attachment portion 722 is returned to an initial shape before being deformed in the radially inward direction, so that the attachment portion 722 is fixed at the engagement hole 851. A clearance is formed between the engagement protrusion 724 and the operation plate 721 in the axial direction of the attachment portion 722 so as to have an approximately same thickness as the attachment wall 85. Accordingly, the attachment wall 85 is held between the engagement protrusion 724 and the operation plate 721, thereby fixing the handle portion 72 at the attachment wall 85 without causing a backlash. While the handle portion 72 is attached at the attachment wall 85 in the aforementioned state, the attachment portion 722 is prevented from being disengaged from the engagement hole 851 because of the engagement protrusion 724.

Furthermore, as illustrated in FIG. 11, while the handle portion 72 is attached at the attachment wall 85, a predetermined clearance is formed between a lower portion of the operation plate 721 and the attachment wall 85, in order to allow the operator to insert a hand into the clearance. In a case where a malfunction and the like occurs at the lid lock apparatus 1 and the lock shaft 6 is not returned to the unlock position by the electric motor 3, the operator is supposed to pull the emergency pull cord 7 in order to pull the lock shaft 6.

In this case, the operator may remove a trim of the trunk and the like of the vehicle, then, is supposed to insert the hand into an operation hole formed at the inner panel in order to hold the lower portion of the operation plate 721 attached at the inner panel. When the operator rotates the handle portion 72 in a clockwise direction in FIG. 11 about the attachment portion 722 (in a direction indicated by an arrow in FIG. 11), an engagement between the engagement protrusion 724 and the engagement hole 851 is released, so that the handle portion 72 is easily detachable from the attachment wall 85.

Then, when the operator pulls the handle portion 72, the lock shaft 6 is displaced to the unlocked position while rotating the worm wheel 5, the worm 4 and the electric motor 3, thereby disengaging the lock shaft 6 from the lid 82. The lid 82 is biased in a direction of closing the lid box 81 by a spring. Therefore, after the fuel is supplied, the lock shaft 6 does not need to be moved back to the locked position. Furthermore, when the emergency pull cord 7 is pulled, the cord guiding portion 66 of the lock shaft 6 contacts the cord portion 73, so that a pulling direction of the cord portion 73 is limited to a substantially orthogonal direction relative to an axis of the connecting hole 65a. Therefore, the shaft engagement portion 71 is prevented from being twisted and being disengaged from the connecting hole 65a.

According to the embodiment, because the shaft engagement portion 71, the handle portion 72 and the cord portion 73 of the emergency pull cord 7 are integrally formed by the synthetic resin material, a length of the emergency pull cord 7 does not need to be adjusted and furthermore, the cord portion 73 on the one hand and the shaft engagement portion 71 and the handle portion 72 on the other hand do not need to be connected with each other by means of caulking and the like. Accordingly, a number of components used for the lid lock apparatus 1 may be reduced, and furthermore, productivity of the lid lock apparatus 1 may be increased, which may result in reducing manufacturing costs of the lid lock apparatus 1.

Furthermore, because the shaft engagement portion 71 includes the snap-fit fastener (712, 715), only the insertion portion 712 needs to be inserted into the connecting hole 65a in order to connect the emergency pull cord 7 with the lock shaft 6. Accordingly, the lid lock apparatus 1 that is easily manufactured with less manufacturing costs may be achieved. Still further, because the snap-fit fastener (722) is formed at the handle portion 72, only the attachment portion 722 needs to be inserted into the engagement hole 851 in order to fix the handle portion 72 at the vehicle body 8. Therefore, the handle portion 72 is easily fixed at the vehicle body 8, which may result in reducing costs relating to the attachment of the lid lock apparatus 1 to the vehicle.

According to known lid lock apparatuses, generally, a surface fastener needs to be provided at each of a handle portion provided at an end portion of an emergency pull cord and a vehicle body. The surface fasteners provided at the respective handle portion and the vehicle body are engaged with each other, thereby fixing the handle portion at the vehicle body. Therefore, a number of components used for the known lid lock apparatus may be increased and furthermore, because the surface fastener needs to be provided at a precise position of the vehicle body without causing displacement and detachment, manufacturing costs of the known lid lock apparatuses further increase because of an increase of man hours necessary for attaching the handle portion on the vehicle body.

According to the embodiment, because a surface fastener does not need to be provided at each of the handle portion and the vehicle body. Therefore, the number of components used for the lid lock apparatus 1 and man hours necessary for attaching the handle portion on the vehicle body may be reduced, thereby largely reducing the manufacturing costs of the lid lock apparatus 1. Furthermore, because the cord guiding portion 66 for restricting the pulling direction of the cord portion 73 by the operator in the manner where the cord guiding portion 66 contacts the cord portion 73 of the emergency pull cord 7 is formed at the rear end portion of the lock shaft 6, the shaft engagement portion 71 is prevented from being pulled in a direction by which the shaft engagement portion 71 is disengaged from the lock shaft 6.

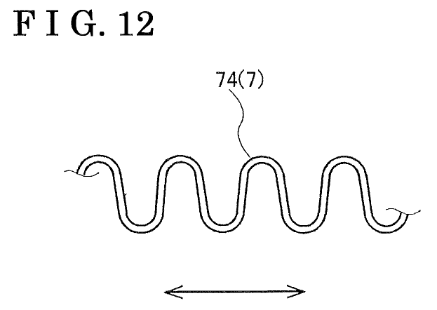

Illustrated in FIG. 12 is a modified example of the lid lock apparatus 1 according to the first embodiment. More specifically, the cord portion 73 of the emergency pull cord 7 is modified. As illustrated in FIG. 12, the emergency pull cord 7 includes a cord portion 74, which is formed in a wave-like shape by a synthetic resin material. Accordingly, the cord portion 74 is configured so as to be stretchable in a length direction thereof, so that the cord portion 74 is flexible to changes in a distance between an attachment position of the shaft engagement portion 71 and an attachment position of the handle portion 72. Therefore, the lid lock apparatus 1 may be adapted to various vehicle types and various specifications of the vehicle. Furthermore, the lid lock apparatus 1 may be flexible to fluctuation of attachment dimension occurring at an identical type of vehicles.

### Other Embodiments

Changes and modifications may be adapted to the lid lock apparatus 1 according to the embodiment and the modified embodiment. For example, the lid lock apparatus 1 may be modified so that the insertion portion 712 having the hooks 715 may be formed at the lock shaft 6 and the connecting hole 65a, at which the insertion portion 712 engages, may be formed at the shaft engagement portion 71. Furthermore, the lid lock apparatus 1 may be adapted to a lid lock apparatus, which is configured so that the lock shaft 6 is normally biased towards the locked position by means of a spring and the like, as disclosed in JPH4-302680A, and so that the lock shaft 6 is displaced to the unlocked position so as to resist against a biasing force generated by the spring in response to an actuation of the electric motor 3. Still further, the handle portion 72 may be attached at the vehicle body 8 by means of surface fasteners.

According to the embodiments, the lid lock apparatus 1 further includes the first snap-fit fastener (712, 715) formed at either one of the lock shaft 6 and the shaft engagement portion 71, wherein the first snap-fit fastener (712, 715) is deformingly inserted into the connecting hole 65a formed at the other one of the lock shaft 6 and the shaft engagement portion 71 and is returned to the initial shape when the first snap-fit fastener (712, 715) passes through the connecting hole 65a, so that the first snap-fit fastener (712, 715) is fixed at the connecting hole 65a.

According to the embodiments, the lid lock apparatus 1 further includes the second snap-fit fastener (722) formed at the handle portion 72, wherein the second snap-fit fastener (722) is configured so as to be deformingly inserted into the engagement hole 851 formed at the vehicle body 8 and is fixed thereat.

According to the embodiments, the lock shaft 6 includes the cord guiding portion 66 at the second end portion, and the cord guiding portion 66 restricts the pulling direction of the cord portion 73 when being pulled by the operator in the manner where the cord portion 73 contacts the cord guiding portion 66.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A lid lock apparatus for a vehicle, comprising:
a driving motor accommodated within a housing;
a shaft member supported within the housing so as to be movable in an axial direction thereof and configured so that a first end portion of the shaft member protrudes from the housing to be engageable with a lid body provided at a vehicle body in order to retain the lid body to be unopenable by an engagement between the first end portion of the shaft member and the lid body and so that the shaft member retracts in response to an actuation of the driving motor in order to disengage the shaft member from the lid body; and
an operating pull cord including a shaft engagement portion made of a synthetic resin material and attached at a second end portion of the shaft member, a handle portion formed with the shaft engagement portion as a unit by the synthetic resin material and being holdable by an operator and a cord portion integrally formed with the shaft engagement portion and the handle portion by use of the synthetic resin material and connecting the shaft engagement portion and the handle portion, and configured so as to retract the first end portion of the shaft member towards an inside of the housing when the operator pulls the handle portion in order to disengage the shaft member from the lid body.

2. The lid lock apparatus for the vehicle according to claim 1 further comprising a first snap-fit fastener formed at either one of the shaft member and the shaft engagement portion, wherein the first snap-fit fastener is deformingly inserted into an engagement hole formed at the other one of the shaft member and the shaft engagement portion and is returned to an initial shape when the first snap-fit fastener passes through the engagement hole, so that the first snap-fit fastener is fixed at the engagement hole.

3. The lid lock apparatus for the vehicle according to claim 1 further comprising a second snap-fit fastener formed at the handle portion, wherein the second snap-fit fastener is configured so as to be deformingly inserted into an attachment hole formed at the vehicle body and is fixed thereat.

4. The lid lock apparatus for the vehicle according to claim 2 further comprising a second snap-fit fastener formed at the handle portion, wherein the second snap-fit fastener is configured so as to be deformingly inserted into an attachment hole formed at the vehicle body and is fixed thereat.

5. The lid lock apparatus for the vehicle according to claim 1, wherein the shaft member includes a guide portion at the second end portion, and the guide portion restricts a pulling direction of the cord portion when being pulled by the operator in a manner where the cord portion contacts the guide portion.

6. The lid lock apparatus for the vehicle according to claim 2, wherein the shaft member includes a guide portion at the second end portion, and the guide portion restricts a pulling direction of the cord portion when being pulled by the operator in a manner where the cord portion contacts the guide portion.

7. The lid lock apparatus for the vehicle according to claim 3, wherein the shaft member includes a guide portion at the second end portion, and the guide portion restricts a pulling direction of the cord portion when being pulled by the operator in a manner where the cord portion contacts the guide portion.

8. The lid lock apparatus for the vehicle according to claim 4, wherein the shaft member includes a guide portion at the second end portion, and the guide portion restricts a pulling direction of the cord portion when being pulled by the operator in a manner where the cord portion contacts the guide portion.
